(19) United States
(12) Patent Application Publication
(10) Pub. No.: US 2018/0147922 A1
(43) Pub. Date: May 31, 2018

(54) Method for Controlling an Electrically Adjustable Sunroof of a Motor Vehicle

(71) Applicant: Daimier AG, Stuttgart (DE)

(72) Inventors: Volker ENTENMANN, Affalterbach (DE); Oliver FRITZ, Ostfildern (DE); Susanne SCHILD, Gaertringen (DE); Tingting ZHANG-XU, Sindelfingen (DE)

(73) Assignee: Daimier AG, Stuttgart (DE)

(21) Appl. No.: 15/316,483

(22) PCT Filed: Feb. 21, 2015
(86) PCT No.: PCT/EP2015/000397

§ 371 Date: Dec. 5, 2016

(30) Foreign Application Priority Data
Jun. 6, 2014 (DE) 10 2014 008 432.9

(51) Int. Cl. B60J 7/057; G06F 3/0488; B60J 7/02; B60K 37/06; B60W 50/08

(52) U.S. Cl. CPC B60J 7/0573; G06F 3/0488; B60W 50/08; B60K 37/06; B60J 7/022

(57) ABSTRACT

A method for controlling a sunroof of a motor vehicle that is able to be electrically adjusted by a touch-sensitive touchpad is disclosed. The sunroof is adjusted into a closed position by a first swiping movement across the touchpad. The sunroof is adjusted into an open position by a second swiping movement opposite to the first across the touchpad. The sunroof is specifically controlled depending on a position or movement of the sunroof which is caused by tapping the touchpad. The tapping the touchpad is only registered by a movement of the touchpad that is caused by tapping. A sunroof device and a motor vehicle for implementing such a method are also disclosed.

The invention relates to a method for controlling an electrically adjustable sunroof of a motor vehicle according to the preamble of claim 1. Furthermore, the invention relates to a sunroof device and a motor vehicle for implementing such a method.

Using touch-sensitive touchpads as operating elements in vehicles is already known. Such touch-sensitive touchpads have a two-dimensional sensor structure and detect the touch of one or more fingers, for example based on the concept of “mutual capacitance”.

“Mutual capacitance” is the capacitative coupling between objects or the capacity which occurs between two charge carriers or conductors, wherein electricity that flows through one charge carrier or conductor passes into the other one. In a capacitative touch sensor, the mutual capacitative coupling occurs between an X- and a Y-axis electrode. The measurement according to “mutual capacitance” is implemented by the electrodes of a sensor layer which serves as a receiver and the electrodes of an opposite sensor layer which serve as a sensor. The intersection points of every X-axis electrode of the one sensor layer with the Y-axis electrodes of the other sensor layer are defined as joints. A multi-touch system is based on the measurements of mutual capacitance at each joint of the sensor such that the positions of several simultaneous touches on the touch sensor can be traced.

When using touchpads as operating elements in the vehicle, for example as the operating element for an electrically adjustable sunroof, safety requirements also have to be met in order to avoid accidental activation. Furthermore, the operating unit with the touch-sensitive touchpad in particular also has to meet the respective demand for approval requirements. The more sensitive the sensor of the touch-sensitive touchpad, the more robustly the method for controlling an electrically adjustable sunroof of a motor vehicle having such an operating unit functions.

In order to process sensor data of the two-dimensional sensor structure, the sensor data is interpolated. The interpolation of the sensor data only leads to a good result if the sensor data is complete, i.e. if the sensor data has been procured for the entire orthogonal matrix.

The object of the present invention is to create a method for controlling an electrically adjustable sunroof of a motor vehicle by means of a touch-sensitive touchpad as an operating unit, and a sunroof device for a motor vehicle, and a motor vehicle having a sunroof device, by means of which the sunroof is particularly easy to operate.

This object is solved according to the invention by a method having the features of claim 1. Furthermore, this object is solved by a sunroof device having the features of claim 7 and by a motor vehicle having the features of claim 9. Advantageous embodiments having expedient developments of the invention are specified in the remaining claims.

In order to create a method for controlling an electrically adjustable sunroof of a motor vehicle by means of a touch-sensitive touchpad as an operating unit, by means of which the sunroof is particularly easy to operate, the method steps described in the following are provided.

Adjusting the sunroof into a closed position is caused by a first swiping movement across the touchpad. The movement of the sunroof during adjusting can thus be caused by an electric motor, for example, which is controlled by the operating unit. The closed position is thus the position in which the sunroof completely seals an opening in a roof or roof liner of a motor vehicle. Adjusting the sunroof into the closed position is caused by the occupant of the motor vehicle swiping one or more fingers, for example, across the touch-sensitive touchpad, in particular in the direction in which the sunroof has to be adjusted to close the opening of the roof of the motor vehicle. In particular, this is the case if the sunroof is in the open position. The sunroof can also be automatically further adjusted after completion of the swiping movement until it is in the closed position.

In a further method step, adjusting the sunroof into the open position is caused by a second swiping movement across the touchpad, opposite to the first. Thus, the open position, in contrast to the closed position, is a position in which the opening in the roof of the motor vehicle is at least partially or completely uncovered. The second swiping movement, opposite to the first, is a swiping movement, for example, in which the occupant of the motor vehicle swipes across the touch-sensitive touchpad, in particular in the direction in which the sunroof has to be adjusted in order to achieve the open position. The sunroof can also be automatically further adjusted after completion of the swiping movement until it is in the open position.

Thus in both swiping movements the occupant of the motor vehicle preferably swipes in the direction of the adjusting movement of the sunroof. As a result, the sunroof is particularly easy to operate since this corresponds to an intuitive movement.

In a further method step, a specific controlling of the sunroof, depending on a position or movement of the sunroof, is caused by tapping the touchpad. That is to say, there is a possibility to control the sunroof which is dependent on the present state of the sunroof. Thus, by tapping the touchpad, a different adjusting of the sunroof, for example, can be caused when it is in the open position than when it is in the closed position. In addition, controlling can also cause a different controlling with a position between the open position and the closed position. A further exemplary state is when the sunroof is adjusted exactly between one of these two positions and thus moves. Tapping thus corresponds substantially, for example, to pressing with one or more fingers for example against the touchpad without performing a swiping movement. Thus the sunroof is particularly easy to operate since it is not only controlled by swiping movements but also by tapping the touchpad that can be carried out by the occupant in a particularly simple manner. Such tapping can thus be coupled, for example, with a particularly intuitive controlling of the sunroof.

A touch-sensitive touchpad, also known as a touch slider, is thus perceived as particularly innovative by a user and has a particular excitement potential.

In an advantageous embodiment of the invention it is provided that an adjusting movement of the sunroof is stopped by tapping the touchpad. Thus, the occupant of the motor vehicle does not have to wait for the sunroof to have completely carried out a control order before he can give the next control order for adjusting the sunroof. Tapping during the adjusting movement of the sunroof therefore presents a kind of universal termination order. An occupant can thus immediately take back an operation order. Accordingly, the sunroof is particularly easy and intuitive to operate.

In a particularly advantageous embodiment of the invention it is provided that the sunroof is adjusted into a lifting position by tapping the touchpad for a sunroof that is not moving. The lifting position is a position that is different to the open position and the closed position, which is also usually not passed through by the sunroof when the sunroof is adjusted from the open position into the closed position and vice versa. For example, when the sunroof is adjusted from the closed position into the open position—or vice versa—it performs a substantially translatory movement. That is to say, it drives along on rails, for example, such that the opening in the roof of the motor vehicle is at least partially uncovered or sealed. In the lifting position, the sunroof rotates substantially from the closed position about a fixed point, often a front end of the sunroof, such that a gap in the roof of the motor vehicle is uncovered. In the example, this gap is then on a side facing away from the forwards travel direction of the motor vehicle such that a production of sound by an airstream is particularly reduced while the sunroof can be further used for ventilating an internal space of the motor vehicle.

The sunroof thus functions as a kind of flap, wherein for adjusting into the lifting position, usually the sunroof is initially adjusted into the closed position before it carries out a rotation movement immediately afterwards. The lifting position is advantageous because a smaller sound development in the internal space emerges during driving the motor vehicle than with a sunroof in the open position, the occupants of the motor vehicle are furthermore protected from the sun, and they can be provided with fresh air. In a sunroof that is not moving, moving the sunroof into this advantageous position is thus particularly easily caused by tapping the touchpad. In a sunroof that is moving, even a simple double tap, for example, can incidentally be enough to cause the sunroof to adjust into this lifting position, wherein the first tap causes the adjusting movement to stop, as already previously described.

If the approval requirements for motor vehicles in a specific country do not permit the embodiment of the invention in the manner previously described, then the embodiment of the method is specified to the effect that adjusting the sunroof into a lifting position by tapping is only caused when the sunroof is not moving and is in the closed position and not when it is in the open position or a different position.

It is furthermore advantageous if provision is made for the sunroof that is not moving and is not in the closed position to be adjusted in the direction of the closed position only when the touchpad is tapped. That is to say that the occupant of the motor vehicle can cause a manual adjusting of the sunroof from the open position in the direction of the closed position. Thus he can also adjust the sunroof into a position between the open position and the closed position. That is to say, he can thus manually make the opening in the roof of the motor vehicle that has been uncovered by the sunroof smaller. In other words, an operator of the sunroof presses on the touchpad for as long as it takes for it to achieve the desired position, in particular between the open position and the closed position. As soon as he stops tapping on the touchpad, the movement of the sunroof also stops. Thus, a certain position of the sunroof can be particularly easily manually positioned by the user, the operation is thus intuitive.

It has been shown to be particularly advantageous when tapping the touchpad is registered only by a movement of the touchpad caused by tapping. This movement can be a tilt of the touchpad for example about a certain axis or even a movement of the touchpad in the vertical direction of the vehicle, i.e. up into a panelling of the roof of the motor vehicle. The movement of the touchpad can thus be very small, for example 1 millimetre or less. It can sometimes be very difficult to distinguish between a particularly long swiping movement and a simple tapping of the touchpad by means of the touch-sensitive touchpad. Because of this, particularly expensive sensors in the touchpad are sometimes required and/or complicated algorithms are necessary to make this distinction, which require a high computational cost. As a result of the touchpad being moved by tapping and tapping the touchpad only being registered during this movement of the touchpad, this distinction can be made in a particularly simple and inexpensive manner. At the same time, it is also no longer necessary for the user to swipe more quickly across the touchpad during the two swiping movements than with a certain speed provided such that the operating unit can distinguish between a swiping movement and tapping. Thus, the sunroof is once again now easier to operate.

Furthermore, it is advantageous when tapping the touchpad or one of the swiping movements across the touchpad with one and/or several fingers is distinguished from tapping the touchpad or a swiping movement across the touchpad with a different body part and/or item by means of an algorithm and is activated depending on this distinction. In other words, the sunroof should be able to be controlled via the touchpad exclusively by fingers, and not by other body parts and/or items. Thus, unwanted false triggerings, for example by a forehead, a nose, a knee, a foot, an elbow or a ball are avoided. Thus the sunroof can be controlled particularly reliably. Furthermore, it is thus no longer necessary to have to avoid by a constructive means that such a false triggering by a different body part and/item is possible. It is thus in particular no longer necessary to sink the operating unit of the sunroof in a hollow of a roof interior panelling, also called roof liner. Thus it is possible to form the inner space of the motor vehicle as a flat surface at the place of the operating unit with the touch-sensitive touchpad, which results in a particularly aesthetic overall impression.

The advantages and embodiments described above in connection with the method according to the invention apply in the same way to the sunroof device for a motor vehicle having a sunroof and a control device having a touch-sensitive touchpad as an operating unit, said control device also being formed to control the sunroof according to one of the preceding options.

Furthermore, it is advantageous when the touchpad of the sunroof device comprises a switch which is able to be switched by a movement of the touchpad. Such a switch can be a mechanical pressure or rocker switch in particular which registers the movement of the touchpad. Thus, the particularly simple distinction between a swiping movement and tapping the touchpad is able to be realised inexpensively and in a such a way that it takes up little installation space.

The advantages and embodiments described above in connection with the method according to the invention for controlling an electrically adjustable sunroof and having the described advantages and embodiments of the sunroof device according to the invention apply in the same way to the motor vehicle having the sunroof device. Thus it is provided that the touchpad is arranged on the roof liner of the motor vehicle. This arrangement of the touchpad on the roof liner of the motor vehicle corresponds to a particularly close arrangement to the sunroof itself. This positioning corresponds to a location in which a user of the sunroof intuitively assumes the operating unit. Thus, in this way, the sunroof is particularly easy to operate.

Further advantages, features and details of the invention can be seen in the following description of preferred exemplary embodiments and by reference to the drawings. Here is shown in:

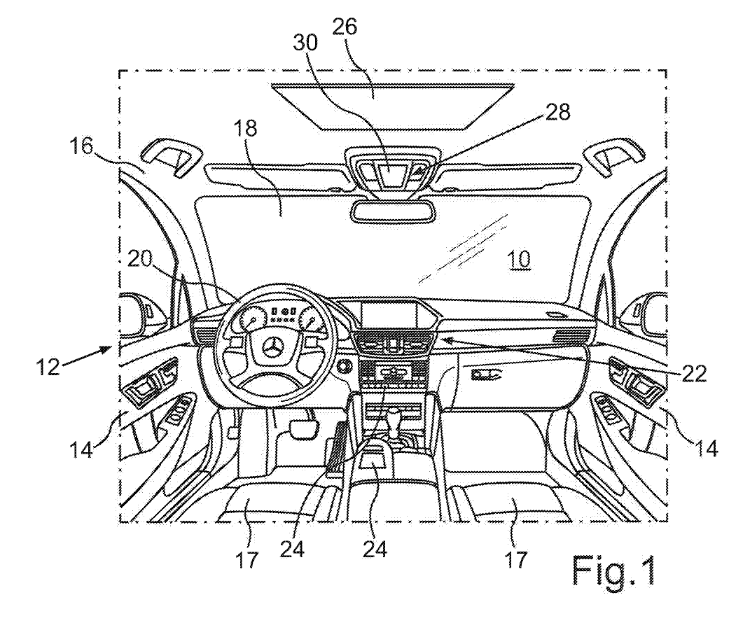

FIG. 1 a schematic perspective view of an internal space of a motor vehicle having a sunroof device with a sunroof and control device with a touch-sensitive touchpad as an operating unit;

and

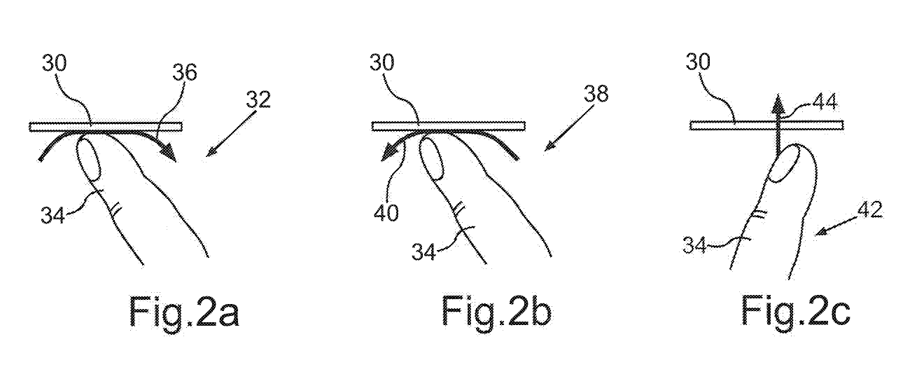

FIG. 2a-c schematic depictions of the different movements for controlling the sunroof by means of the touch-sensitive touchpad.

FIG. 1 shows the inner space 10 of an exemplary motor vehicle 12 in a schematic perspective view. The inner space 10 of the motor vehicle 12 is thus confined by two side doors 14, a roof liner 16 and a windscreen 18. Furthermore, two seats 17 for each occupant of the motor vehicle are depicted, as well as a steering wheel 20 and a central console 22 having respective operating elements 24.

A sunroof 26 having an operating unit 28 which comprises a touch-sensitive touchpad 30 is arranged on the roof liner 16 of the motor vehicle 10. The sunroof 26 is thus shown in its closed position, that is to say, it completely covers an opening in the roof liner 16.

The sunroof 26 can be adjusted into this closed position by a swiping movement 32 across the touchpad 30, which is shown schematically in FIG. 2a. For this reason, an occupant of the motor vehicle 10, for example, must swipe across the touchpad 30 with his finger 34 in the direction of the depicted arrow 36. The occupant thus swipes across the touch-sensitive touchpad 30 from the direction of the sunroof 26 in the direction of the windscreen 18 of the motor vehicle 10. This also corresponds to the movement direction of the sunroof 26 from the open position, in which the opening in the roof liner 16 of the motor vehicle 10 is at least partially uncovered, into the closed position.

FIG. 2b shows in a schematic depiction of how adjusting the sunroof 26 into the open position can be caused by a second swiping movement 38 opposite to the first swiping movement 32. For this purpose, the occupant of the motor vehicle 10 swipes with his finger 34 in an exactly opposite direction across the touch-sensitive touchpad 30. That is to say, he guides his finger 34 across the touchpad 30 from the windscreen 18 in the direction of the sunroof 26, which here corresponds to the movement direction of the sunroof 26 from the closed position into the open position. Both swiping movements 32, 38 are thus detected by the touch-sensitive touchpad 30, for example, by means of sensors of a multi-capacitance touchpad.

FIG. 2c shows in a further schematic view, how a specific controlling of the sunroof 26 is caused by tapping 42 the touchpad 30 depending on a position or movement of the sunroof 26. For this purpose, the occupant of the motor vehicle 10 presses on the touchpad 30 with his finger 34 which is also depicted by the arrow 44.

This tapping 42 in the form of pressing can likewise move the touchpad 30 in the direction of the arrow 44 in an alternative embodiment. Tapping 42 can then be registered by a mechanical pressure switch for example, which is switched by the movement of the touchpad 30 in the direction of the arrow 44. Thus a particularly easy and inexpensive distinction between the two swiping movements 32, 38 and tapping 42 is possible.

While the two swiping movements 32, 38 cause a complete automatic opening or complete automatic closing of the sunroof 26, several specific controls of the sunroof 26 are assigned to tapping 42 of the touchpad 30 depending on the position or the movement of the sunroof 26.

In the case of a sunroof 26 that is not moving and is in the closed position, the sunroof can be adjusted into a lifting position for example, after tapping 42 the touchpad 30. The lifting position is a position in which, for example, only one gap facing away from the windscreen 18 is uncovered on the side of the sunroof 26 facing away from the windscreen 18 by the sunroof rotating about its longitudinal side facing the windscreen 18.

A further possibility is manual closing in a sunroof 26 that is still and not closed. That is to say, the sunroof is in the open position or a position between the open position and the closed position and is also thus not moving. By tapping 42 the touchpad 30 and subsequently holding the finger 34 on the touchpad 30, the mechanical pressure switch for example is permanently switched for conduction. As long as this switch is permanently switched for conduction, the sunroof 26 is adjusted from its position at the start of the switching in the direction of the closed position. As soon as the occupant of the motor vehicle 10 takes his finger 34 off the touchpad 30 and thus the tapping 42 ends, the switch is no longer able to conduct and this closing movement is stopped. Thus the sunroof 26 can be particularly easily adjusted into an individual position.

In the case of a moving sunroof 26, tapping 42 the touchpad 30 causes this adjusting movement to stop. In a running, i.e. an adjusting sunroof 26, an adjusting movement is thus interrupted. This is also possible without the touchpad 30 being moved by tapping 42, but by simply touching the touchpad 30 for example. Thus a particularly easy operation of the sunroof 26 is possible.

Overall, particularly great client enthusiasm a high acceptance from a user and an intuitive understanding of the operating unit 28 are connected to the use of a touch-sensitive touchpad 30 as an operating unit 28 for controlling an electrically adjustable sunroof 26. As a result of a touch-sensitive touchpad 30 being able to distinguish between an operating movement by a finger 34 and an operating movement by different body parts and/or items, it is also particularly reliable. Moreover, a constructive means, for example sinking the touchpad 30 in the roof liner 16 of the motor vehicle 12 in a hollow, does not have to provided in order to prevent an unintentional operation of the sunroof 26. Thus more creative freedoms are possible, in particular a flat surface can be formed at the position of the operating unit 28 on the roof liner 16 of the motor vehicle 12.

1.-9. (canceled)

10. A method for controlling an electrically adjustable sunroof of a motor vehicle by a touch-sensitive touchpad as an operating unit, comprising the steps of:
adjusting the sunroof into a closed position by a first swiping movement across the touch-sensitive touchpad;
adjusting the sunroof into an open position by a second swiping movement across the touch-sensitive touchpad, wherein the second swiping movement is opposite to the first swiping movement; and
controlling the sunroof by tapping the touch-sensitive touchpad;
wherein the tapping is only registered by a movement of the touch-sensitive touchpad caused by the tapping.

11. The method according to claim 10, wherein an adjusting movement of the sunroof is stopped by the tapping.

12. The method according to claim 10, wherein the sunroof is adjusted into a lifting position by the tapping when the sunroof is not moving.

13. The method according to claim 10, wherein the sunroof, which is not moving and is not in the closed position, is adjusted in a direction of the closed position by the tapping.

14. The method according to claim 10, wherein the tapping or one of the first and second swiping movements is performed by a first body part, wherein a further tapping of the touch-sensitive touchpad or a further swiping movement across the touch-sensitive touchpad performed by a second body part or an item is distinguished, and wherein the sunroof is controlled depending on the distinction.

15. A sunroof device for a motor vehicle, comprising:
a sunroof; and
a control device having a touch-sensitive touchpad as an operating unit, wherein the control device controls the sunroof according to the method of claim 10.

16. The sunroof device according to claim 15, wherein the touch-sensitive touchpad includes a switch that is switchable by the movement of the touch-sensitive touchpad.

17. A motor vehicle, comprising:
a sunroof; and
a control device having a touch-sensitive touchpad as an operating unit, wherein the control device controls the sunroof according to the method of claim 10;
wherein the touch-sensitive touchpad is disposed on a roof liner of the motor vehicle.
